(19) United States
(12) Patent Application Publication
(10) Pub. No.: US 2019/0385800 A1
(43) Pub. Date: Dec. 19, 2019

(54) TOUCH MODULE

(71) Applicant: Primax Electronics Ltd., Taipei (TW)

(72) Inventor: Tai-Sou Huang, Taipei (TW)

(21) Appl. No.: 16/110,305

(22) Filed: Aug. 23, 2018

(30) Foreign Application Priority Data
Jun. 15, 2018 (TW) 107120719

(51) Int. Cl. H01H 13/14; G06F 3/0354; H01H 13/52; G06F 1/16

(52) U.S. Cl. CPC H01H 13/14; G06F 3/03547; H01H 13/52; H01H 2221/058; G06F 1/1671; H01H 2221/01; G06F 1/1616

(57) ABSTRACT

A control module includes a frame structure, a touchpad assembly, a supporting element and a rotating shaft. The frame structure includes a first sheathing structure. The touchpad assembly is located over the frame structure. The supporting element is arranged between the frame structure and the touchpad assembly. The supporting element includes a supporting body a second sheathing structure. The rotating shaft is penetrated through the first sheathing structure and the second sheathing structure. A hinge structure is defined by the rotating shaft, the first sheathing structure and the second sheathing structure collaboratively. Due to the hinge structure, the touchpad assembly is swung along a fixed direction. While the touchpad assembly is pressed down, the second sheathing structure is swung relative to the first sheathing structure by using the rotating shaft as a pivotal shaft. Consequently, the touchpad assembly is swung stably, and the touch module is operated stably.

### FIELD OF THE INVENTION

The present invention relates to an input device, and more particularly to a touch module that is installed on a computer.

### BACKGROUND OF THE INVENTION

The widely-used peripheral input device of a computer system includes for example a mouse device, a keyboard device, a trackball device, or the like. With the progress of the times, a touch module is introduced into the market. By directly using the user's fingers to operate the touch module, the computer system can be correspondingly controlled. The applications of the touch module are very extensive. In the early stage, a notebook computer is equipped with a touch module. By operating the touch mouse, the movement of a cursor may be controlled or a corresponding icon of a user interface may be clicked without the need of using a mouse to operate the notebook computer. In an advantage of the touch module, the touch module can be intuitively operated by the user and thus various commands can be correspondingly executed.

FIG. 1 schematically illustrates a conventional notebook computer with a touch module. The touch module 1 is installed on a computer casing 21 of a notebook computer 2. Moreover, the touch module 1 is partially exposed outside the computer casing 21. When the touch module 1 is touched by the user's finger, the notebook computer 2 is correspondingly controlled. For example, when the user's finger is placed on the touch module 1 and moved on the touch module 1, a cursor 23 shown on a display screen 22 of the notebook computer 2 is correspondingly moved. Alternatively, the user may press down the touch module 1 to execute a button function of the notebook computer 2. In other words, the touch module 1 can be used to replace the mouse. Since it is not necessary to additionally carry and install the mouse, the use of the touch module is more convenient.

The inner structure of the touch module will be described as follows. FIG. 2 is a schematic cross-sectional side view illustrating the conventional touch module. Please refer to FIGS. 1 and 2. The touch module 1 is installed in the computer casing 21 and partially exposed outside the computer casing 21. The touch module 1 comprises a frame structure 11, a touchpad assembly 12, a supporting metal block 13 and a sponge structure 14. The frame structure 11 is disposed on the computer casing 21. The frame structure 11 comprises a triggering part 111. The sponge structure 14 is attached on an edge of the frame structure 11 through an adhesive. Moreover, the supporting metal block 13 is attached on the sponge structure 14 through an adhesive. The touchpad assembly 12 is located over the frame structure 11. A first end of the touchpad assembly 12 is connected with the supporting metal block 13 through an adhesive. The touchpad assembly 12 comprises a covering plate 121, a circuit board 122 and a switch element 123. A first end of the circuit board 122 is connected with the supporting metal block 13. The switch element 123 is disposed on a bottom surface of the circuit board 122 and located at a second end of the circuit board 122. The covering plate 121 is disposed on the circuit board 122 and exposed outside the computer casing 21.

FIG. 3 is a schematic cross-sectional side view illustrating the conventional touch module, in which the touchpad assembly is pressed down. Please refer to FIGS. 1, 2 and 3. When the user's finger is placed on the touchpad assembly 12 to press down the touchpad assembly 12, a second end of the touchpad assembly 12 (e.g., the position corresponding to the switch element 123) is swung downwardly relative to the computer casing 21 by using the supporting metal block 13 and the sponge structure 14 as fulcrums. As the touchpad assembly 12 is pressed down, the sponge structure 14 is compressed in response to the pressing force. Consequently, the touchpad assembly 12 is swung downwardly. While the touchpad assembly 12 is swung downwardly, the switch element 123 on the circuit board 122 and the triggering part 111 of the frame structure 11 are contacted with each other. Meanwhile, the switch element 123 is triggered to generate a corresponding key signal to the notebook computer 2. According to the key signal, the notebook computer 2 executes a corresponding command. When the user's finger is not placed on the touchpad assembly 12, the touchpad assembly 12 is swung upwardly and returned to its original position in response to the internal elastic force of the switch element 123 and the elastic restoring force of the sponge structure 14. Due to the above operations, the conventional touch module 1 can achieve the button function to replace the mouse.

In the conventional touch module 1, the touchpad assembly 12 is fixed on the supporting metal block 13. The sponge structure 14 made of a soft material is located under the supporting metal block 13. While the touchpad assembly 12 is pressed down, the sponge structure 14 is compressed and thus the touchpad assembly 12 is correspondingly swung. However, the conventional touch module 1 still has some drawbacks. For example, the sponge structure 14 is irregularly compressed in various directions. Since the touchpad assembly 12 is swung unstably, the tactile feel of the conventional touch module 1 is impaired.

Therefore, there is a need of providing a touch module that is capable of being stably operated.

### SUMMARY OF THE INVENTION

An object of the present invention provides a touch module that is capable of being stably operated.

In accordance with an aspect of the present invention, there is provided a touch module. The touch module is installed on a computer casing. The control module includes a frame structure, a touchpad assembly, a supporting element and at least one rotating shaft. The frame structure includes at least one first sheathing structure. The touchpad assembly is located over the frame structure and partially exposed outside the computer casing. While the touchpad assembly is pressed down and swung relative to the computer casing, the touchpad assembly is contacted with the frame structure. Consequently, a corresponding key signal is generated. The supporting element is arranged between the frame structure and the touchpad assembly. The supporting element includes a supporting body and at least one second sheathing structure. The supporting body is disposed on the frame structure and connected with the touchpad assembly. The at least one second sheathing structure is externally extended from the supporting body. Each of the at least one rotating shaft is aligned with a corresponding one of the at least one first sheathing structure and a corresponding one of the at least one second sheathing structure. The at least one rotating shaft is penetrated through the corresponding first sheathing structure and the corresponding second sheathing structure. While the touchpad assembly is swung, the at least one second sheathing structure is swung relative to the at least one first sheathing structure by using the at least one rotating shaft as a pivotal shaft, so that the touchpad assembly is swung relative to the computer casing.

In an embodiment, the frame structure includes a frame body and a triggering part. The at least one first sheathing structure is externally extended from a first side of the frame body. The at least one first sheathing structure has a circle hook shape corresponding to the at least one rotating shaft. The triggering part is disposed on a second side of the frame body and contactable with the touchpad assembly. While the touchpad assembly is pressed down, the touchpad assembly is swung relative to the computer casing and connected with the triggering part, so that the touchpad assembly generates the key signal.

In an embodiment, the at least one second sheathing structure is externally extended from a first side of the supporting body. The at least one second sheathing structure has a circle hook shape corresponding to the at least one rotating shaft.

From the above descriptions, the present invention provides the touch module. The frame body comprises the plural first sheathing structures. The supporting element comprises the plural second sheathing structures. The rotating shafts are penetrated through the corresponding first sheathing structures and the corresponding second sheathing structures. The plural rotating shafts, the plural first sheathing structures and the plural second sheathing structures are collaboratively formed as a hinge structure, which is swung along a fixed direction. The sponge structure used in the conventional control module is replaced by the first sheathing structures, the second sheathing structures and the rotating shafts. Since the sponge structure is not used, the irregular deformation is not produced. Consequently, while the touchpad assembly is pressed down, the touch module is not irregularly rocked. The touchpad assembly of the touch module can be swung stably. In other words, the touch module of the present invention is capable of solving the drawbacks of the conventional technologies.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional notebook computer with a touch module;

FIG. 2 is a schematic cross-sectional side view illustrating the conventional touch module;

FIG. 3 is a schematic cross-sectional side view illustrating the conventional touch module, in which the touchpad assembly is pressed;

FIG. 4 is a schematic exploded view illustrating a touch module according to an embodiment of the present invention and taken along a viewpoint;

FIG. 5 is a schematic exploded view illustrating the touch module according to the embodiment of the present invention and taken along another viewpoint;

FIG. 6 is a schematic perspective view illustrating the touch module according to the embodiment of the present invention; and

FIG. 7 is a schematic perspective view illustrating the touch module according to the embodiment of the present invention, in which the touchpad assembly is swung.

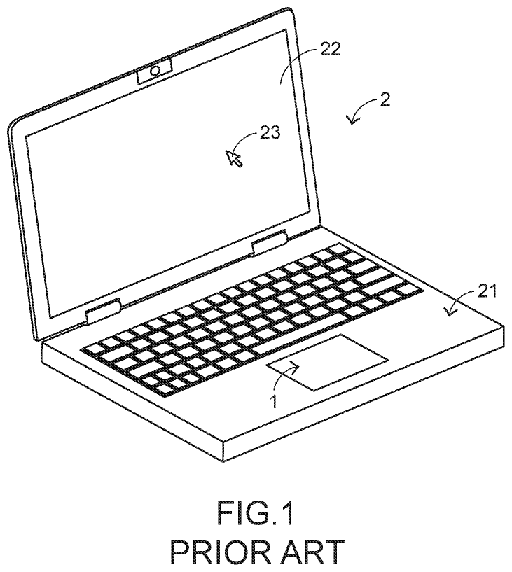

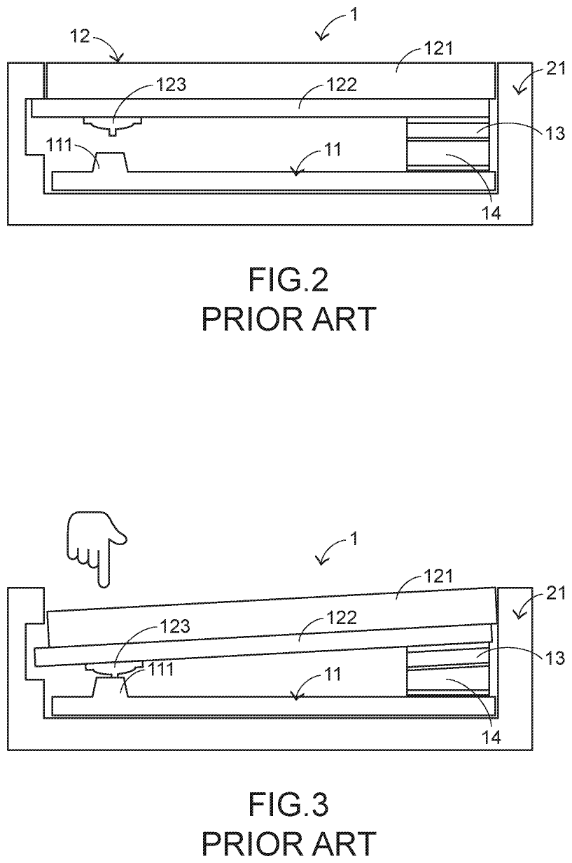

### DETAILED DESCRIPTION OF THE PREFERRED EMBODIMENT

For overcoming the drawbacks of the conventional technologies, the present invention provides a touch module.

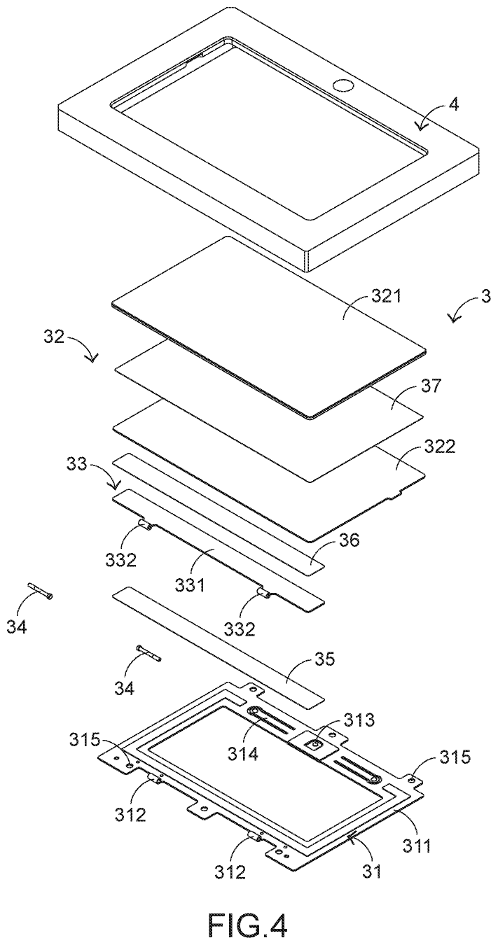

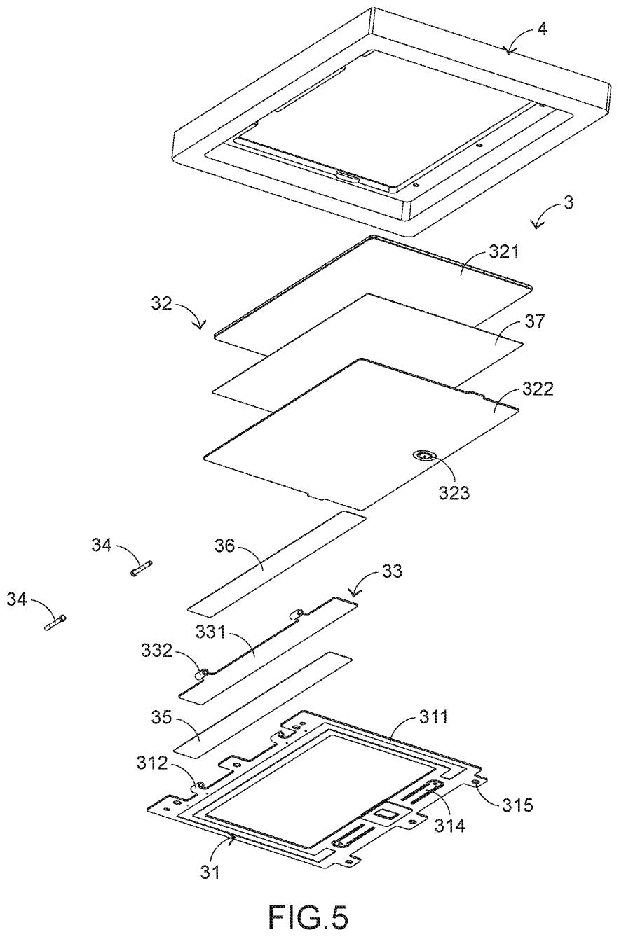

Please refer to FIGS. 4 and 5. FIG. 4 is a schematic exploded view illustrating a touch module according to an embodiment of the present invention and taken along a viewpoint. FIG. 5 is a schematic exploded view illustrating the touch module according to the embodiment of the present invention and taken along another viewpoint. The touch module 3 is installed on a computer casing 4 and partially exposed outside the computer casing 4. In an embodiment, the touch module 3 comprises a frame structure 31, a touchpad assembly 32, a supporting element 33 and plural rotating shafts 34. The frame structure 31 comprises a frame body 311, plural first sheathing structures 312, a triggering part 313, plural elastic structures 314 and plural positioning holes 315. The plural first sheathing structures 312 are externally extended from a first side of the frame body 311. In an embodiment, the first sheathing structures 312 are circle hooks corresponding to the rotating shafts 34. The triggering part 313 is located at a second side of the frame body 311. Moreover, the triggering part 313 is contacted with the touchpad assembly 32. The plural elastic structures 314 are arranged near two opposite sides of the triggering part 313. Moreover, the plural elastic structures 314 are contacted with the touchpad assembly 32 to provide elastic forces to the touchpad assembly 32. The plural positioning holes 315 are formed in a periphery region of the frame body 311. After plural fastening elements (not shown) are penetrated through the corresponding positioning holes 315 and tightened in the computer casing 4, the frame structure 31 is fixed on the computer casing 4.

Preferably but not exclusively, the fastening elements are screws, and the triggering part 313 is disposed on the frame body 311 through an adhering means, an engaging means, an assembling means or any other appropriate coupling means. In another embodiment, the triggering part is integrally formed with the frame body. The plural first sheathing structures 312 and the plural elastic structures 314 are integrally formed with the frame body 311. Moreover, the frame body 311, the plural first sheathing structures 312 and the plural elastic structures 314 are made of metallic material.

The touchpad assembly 32 is located over the frame structure 31 and partially exposed outside the computer casing 4. While the touchpad assembly 32 is pressed down, the touchpad assembly 32 is swung relative to the computer casing 4. Moreover, when the touchpad assembly 32 is contacted with the frame body 31, a corresponding key signal is generated. The supporting element 33 is arranged between the frame body 31 and the touchpad assembly 32 to support the touchpad assembly 32. Consequently, the touchpad assembly 32 is located over the frame body 31. The supporting element 33 comprises a supporting body 331 and plural second sheathing structures 332. The supporting body 331 is arranged near the first side of the frame body 31 and connected with the touchpad assembly 32. The plural second sheathing structures 332 are externally extended from a first side of the supporting body 331. In this embodiment, the plural second sheathing structures 332 are also circle hooks corresponding to the rotating shafts 34. The bottom surface of the supporting body 331 is connected with the frame structure 31 through a first adhesive layer 35. The top surface of the supporting body 331 is connected with the touchpad assembly 32 through a second adhesive layer 36. In an embodiment, the plural second sheathing structures 332 are integrally formed with the supporting body 331, the supporting body 331 and the plural second sheathing structures 332 are made of metallic material, and the first adhesive layer 35 and the second adhesive layer 36 are made of pressure sensitive adhesive.

When the supporting body 331 is disposed on the first side of the frame body 311, the plural second sheathing structures 332 are arranged beside the corresponding first sheathing structures 312, and the plural second sheathing structures 332 are aligned with the corresponding first sheathing structures 312. Each rotating shaft 34 is aligned with one first sheathing structure 312 and one second sheathing structure 332. After the plural second sheathing structures 332 are aligned with the corresponding first sheathing structures 312, the plural rotating shafts 34 are penetrated through the corresponding first sheathing structures 312 and the corresponding second sheathing structures 332. The plural rotating shafts 34, the plural first sheathing structures 312 and the plural second sheathing structures 332 are collaboratively formed as a hinge structure. Consequently, the supporting element 33 is swung relative to the frame body 31 by using the plural rotating shafts 34 as the pivotal shafts.

Please refer to FIGS. 4 and 5 again. The touchpad assembly 32 comprises a covering plate 321, a circuit board 322 and a switch element 323. The covering plate 321 is exposed outside the computer casing 4. The circuit board 322 is located under the covering plate 321 and connected with the covering plate 321. The switch element 323 is disposed on a bottom surface of the circuit board 322 and electrically connected with the circuit board 322. After the circuit board 322 is connected with the supporting element 33, the switch element 323 is located over the triggering part 313 of the frame body 31. In addition, the switch element 323 is not contacted with the triggering part 313. While the covering plate 321 is pressed down, the covering plate 321, the circuit board 322 and the switch element 323 are swung relative to the computer casing 4, and the switch element 323 and the triggering part 313 of the frame structure 31 are contacted with each other. Consequently, the switch element 323 is triggered to generate a corresponding key signal. In the touchpad assembly 32, the circuit board 322 is connected with the covering plate 321 through a third adhesive layer 37. For example, the third adhesive layer 37 is made of pressure sensitive adhesive.

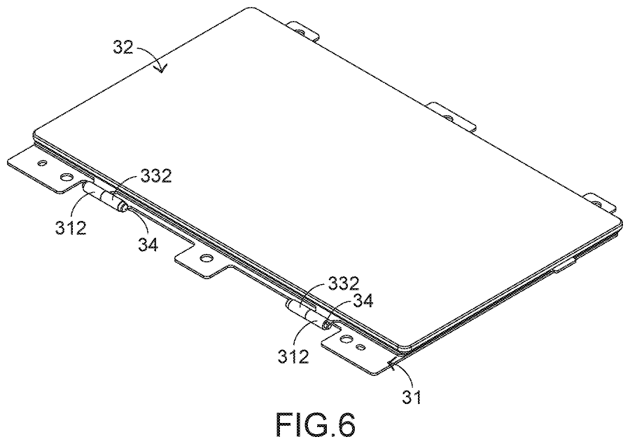

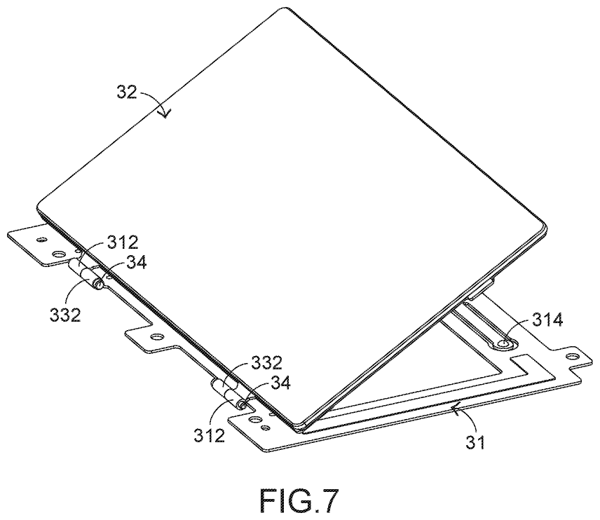

Please refer to FIGS. 6 and 7. FIG. 6 is a schematic perspective view illustrating the touch module according to the embodiment of the present invention. FIG. 7 is a schematic perspective view illustrating the touch module according to the embodiment of the present invention, in which the touchpad assembly is swung. The combined structure of the components of the touch module 3 is shown in FIG. 6. The plural first sheathing structures 312 and the corresponding second sheathing structures 332 are aligned with each other. Moreover, the plural rotating shafts 34 are penetrated through the corresponding first sheathing structures 312 and the corresponding second sheathing structures 332. Due to the rotating shafts 34, the first sheathing structures 312 and the second sheathing structures 332, the touchpad assembly 32 can be smoothly swung relative to the computer casing 4 (see FIG. 7).

The operations of the touch module 3 will be described as follows. When the touch module 3 is not pressed down, the switch element 323 and the triggering part 313 are not contacted with each other. While the covering plate 321 of the touchpad assembly 32 is touched by the user's finger, the circuit board 322 is pushed by the covering plate 321, and the supporting element 33 is pushed by the circuit board 322. Moreover, the second sheathing structures 332 are swung relative to the first sheathing structures 312 by using the plural rotating shafts 34 as the pivotal shafts. Consequently, the covering plate 321, the circuit board 322 and the switch element 323 are swung relative to the computer casing 4. While the touchpad assembly 32 is swung downwardly, the switch element 323 on the bottom surface of the circuit board 322 is pushed by the triggering part 313 of the frame structure 31. Consequently, the switch element 323 is triggered to generate a corresponding key signal. Moreover, the circuit board 322 is contacted with the plural elastic structures 314 of the frame body 31. When the user's finger is not placed on the covering plate 321, the touchpad assembly 32 is swung upwardly and returned to its original position in response to the internal elastic force of the switch element 323 and the elastic restoring forces of the plural elastic structures 314.

From the above descriptions, the present invention provides the touch module. The frame body comprises the plural first sheathing structures. The supporting element comprises the plural second sheathing structures. The rotating shafts are penetrated through the corresponding first sheathing structures and the corresponding second sheathing structures. The plural rotating shafts, the plural first sheathing structures and the plural second sheathing structures are collaboratively formed as a hinge structure, which is swung along a fixed direction. The sponge structure used in the conventional control module is replaced by the first sheathing structures, the second sheathing structures and the rotating shafts. Since the sponge structure is not used, the irregular deformation is not produced. Consequently, while the touchpad assembly is pressed down, the touch module is not irregularly rocked. The touchpad assembly of the touch module can be swung stably. In other words, the touch module of the present invention is capable of solving the drawbacks of the conventional technologies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A touch module installed on a computer casing, the control module comprising:
a frame structure comprising at least one first sheathing structure;
a touchpad assembly located over the frame structure and partially exposed outside the computer casing, wherein while the touchpad assembly is pressed down and swung relative to the computer casing, the touchpad assembly is contacted with the frame structure, so that a corresponding key signal is generated;
a supporting element arranged between the frame structure and the touchpad assembly, and comprising a supporting body and at least one second sheathing structure, wherein the supporting body is disposed on the frame structure and connected with the touchpad assembly, and the at least one second sheathing structure is externally extended from the supporting body; and
at least one rotating shaft, wherein each of the at least one rotating shaft is aligned with a corresponding one of the at least one first sheathing structure and a corresponding one of the at least one second sheathing structure, wherein the at least one rotating shaft is penetrated through the corresponding first sheathing structure and the corresponding second sheathing structure, wherein while the touchpad assembly is swung, the at least one second sheathing structure is swung relative to the at least one first sheathing structure by using the at least one rotating shaft as a pivotal shaft, so that the touchpad assembly is swung relative to the computer casing.

2. The touch module according to claim 1, wherein the frame structure comprises:
a frame body, wherein the at least one first sheathing structure is externally extended from a first side of the frame body, and the at least one first sheathing structure has a circle hook shape corresponding to the at least one rotating shaft; and
a triggering part disposed on a second side of the frame body and contactable with the touchpad assembly, wherein while the touchpad assembly is pressed down, the touchpad assembly is swung relative to the computer casing and contacted with the triggering part, so that the touchpad assembly generates the key signal.

3. The touch module according to claim 2, wherein the frame body comprises:
at least one elastic structure arranged beside the triggering part, wherein the at least one elastic structure is contacted with the touchpad assembly to provide an elastic force to the touchpad assembly; and
plural positioning holes formed in a periphery region of the frame body, wherein after plural fastening elements are penetrated through the corresponding positioning holes and tightened in the computer casing, the frame structure is fixed on the computer casing, wherein the at least one first sheathing structure and the at least one elastic structure are integrally formed with the frame body, and the frame body, the at least one first sheathing structure and the at least one elastic structure are made of metallic material.

4. The touch module according to claim 2, wherein the supporting body is arranged near the first side of the frame body, and the at least one second sheathing structure is arranged beside the corresponding at least one first sheathing structure, wherein the at least one first sheathing structure and the at least one second sheathing structure are aligned with each other, and the at least one rotating shaft is penetrated through the at least one first sheathing structure and the at least one second sheathing structure.

5. The touch module according to claim 1, wherein the supporting body is connected with the frame structure through a first adhesive layer, and the supporting body is connected with the touchpad assembly through a second adhesive layer.

6. The touch module according to claim 1, wherein the at least one second sheathing structure and the supporting body are integrally formed with each other, wherein the supporting body and the at least one second sheathing structure are made of metallic material.

7. The touch module according to claim 1, wherein the touchpad assembly comprises:
a covering plate exposed outside the computer casing;
a circuit board connected with the covering plate and the supporting element; and
a switch element disposed on a bottom surface of the circuit board and electrically connected with the circuit board, wherein when the covering plate is connected with the supporting element and the covering plate is not pressed, the switch element is located over the frame structure and but contacted with the frame structure.

8. The touch module according to claim 7, wherein the circuit board is connected with the covering plate through a third adhesive layer.

9. The touch module according to claim 7, wherein while the covering plate is pressed down, the circuit board is pushed by the covering plate and the supporting element is pushed by the circuit board, wherein the at least one second sheathing structure is swung relative to the at least one first sheathing structure by using the at least one rotating shaft as the pivotal shaft, and the covering plate, the circuit board and the switch element are swung relative to the computer casing.

10. The touch module according to claim 1, wherein the at least one second sheathing structure is externally extended from a first side of the supporting body, and the at least one second sheathing structure has a circle hook shape corresponding to the at least one rotating shaft.
